(19) United States
(12) Patent Application Publication
(10) Pub. No.: US 2026/0361193 A1
(43) Pub. Date: Nov. 12, 2026

(54) VIBRATION MOTOR

(71) Applicant: AAC Microtech (Changzhou) Co., Ltd., Changzhou City (CN)

(72) Inventors: Tong Wang, Changzhou (CN); Hongxu Gao, Changzhou (CN)

(21) Appl. No.: 19/294,367

(22) Filed: Aug. 8, 2025

Related U.S. Application Data
(63) Continuation of application No. PCT/CN2025/094266, filed on May 12, 2025.

(51) Int. Cl. H02K 33/02; H02K 3/12

(52) U.S. Cl. CPC H02K 33/02; H02K 3/12

(57) ABSTRACT

The present disclosure discloses a vibration motor including a hollow housing including an inner wall, a stator including a copper tube mounted on the inner wall and a coil sleeved on an outer surface of the copper tube, a vibration assembly driven by the coil to reciprocate along a first direction, including a magnet unit located inside the copper tube at an interval and arranged opposite to the coil and two mass blocks respectively fixed on two ends of the magnet unit along the first direction, and an elastic member configured to connect the mass block with the housing to suspend the vibration assembly in the housing. The vibration motor in the present disclosure has more stable damping performance and higher structural strength.

### FIELD OF THE PRESENT DISCLOSURE

The present disclosure relates to motor technologies, especially relates to a vibration motor applied in portable mobile terminals.

### DESCRIPTION OF RELATED ART

With the development of the portable mobile terminal technologies, users have increasingly high requirements for haptic effects in different situations such as calling alerts in portable mobile terminals. Therefore, the vibration motors are high required for higher vibration performance and reliability.

In related art, the vibration motor includes a housing, vibration assembly, stator, and a frame made of liquid crystal polymer mounted on the housing. The stator is mounted on the frame, and the vibration assembly are at least partially located inside the frame. Therefore, the vibration assembly is configured to reciprocate in the inner space of the frame. Generally, in order to buffer the movement of the vibration assembly, magnetic liquid which is served as a damper, is provided between the vibration assembly and the frame.

However, the damping performance the magnetic liquid damper is reduced under low temperature environment, and it is not prone to inject the magnetic liquid between the vibration assembly and the frame. Besides, the frame made of liquid crystal polymer has low strength, which may result in vibration failure after long-term movement.

Therefore, it is necessary to provide an improved vibration motor to overcome the problems mentioned above.

### SUMMARY OF THE INVENTION

One object of the present disclosure is to provide a vibration motor with more stable damping performance and higher structural strength.

The vibration motor includes a hollow housing including an inner wall; a stator received in the housing, including: a copper tube mounted on the inner wall; and a coil sleeved on an outer surface of the copper tube; a vibration assembly driven by the coil to reciprocate along a first direction, including: a magnet unit located inside the copper tube at an interval and arranged opposite to the coil; and two mass blocks respectively fixed on two ends of the magnet unit along the first direction; and an elastic member configured to connect the two mass blocks with the housing to suspend the vibration assembly in the housing.

As an improvement, the copper tube includes an annular winding slot depressed from a surface opposite to the housing towards the magnet unit and extending along its circumferential direction, the coil is wound on the winding slot.

As an improvement, the winding slot includes a first winding slot, a second winding slot and a third winding slot successively arranged at intervals along the first direction, the copper tube further includes a first connection slot configured to connect the first winding slot and the second winding slot, and a second connection slot configured to connect the second winding slot and the third winding slot; the coil includes a first wire portion wound in the first winding slot, a second wire portion wound in the second winding slot, a third wire portion wound in the third winding slot, a first connection wire electrically connected the first wire portion with the second wire portion, and a second connection wire electrically connected the second wire portion with the third wire portion; the first connection wire is received in the first connection slot, the second connection wire is received in the second connection slot.

As an improvement, a width of the second wire portion along the first direction is larger than that of the first wire portion and the third wire portion.

As an improvement, the magnet unit includes a first yoke, a second magnet, a second yoke, a second magnet, and a third yoke successively stacked along the first direction; one of the two mass blocks is fixed to the first yoke, and the other of the two mass blocks is fixed to the third magnet.

As an improvement, the first magnet and second magnet are both magnetized along the first direction in an opposite manner.

As an improvement, the housing includes a hollow shell with the inner wall, a first lid and a second lid; the first lid and the second lid are mounted on opposite ends of the shell along the first direction; the copper tube is fixed on the inner wall of the shell.

As an improvement, the elastic member includes a first spring including an end sandwiched between the first lid and the other end fixed on one of the two mass blocks, and a second spring including an end sandwiched between the second lid and the other end fixed on the other one of the two mass blocks.

As an improvement, the vibration motor further includes an electric connector mounted on the copper tube and electrically connected with the coil.

As an improvement, the copper tube further includes a mounting slot formed on one side of the copper tube opposite to the housing, the mounting slot is spaced apart from the winding slot, the electric connector is mounted in the mounting slot.

### BRIEF DESCRIPTION OF THE DRAWINGS

The present disclosure will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

FIG. 1 is an isometric view of a vibration motor in accordance with an exemplary embodiment of the present disclosure.

FIG. 2 is an exploded view of the vibration motor in FIG. 1.

FIG. 3 is a cross-sectional view of the vibration motor taken along line A-A in FIG. 1.

FIG. 4 is an isometric view of a copper tube of the vibration motor in FIG. 1.

FIG. 5 is an isometric view of the vibration motor in FIG. 1 without housing.

FIG. 6 is an isometric view of a copper tube of a vibration motor in accordance with another exemplary embodiment of the present disclosure.

FIG. 7 is a schematic diagram of a coil wound on the copper tube in FIG. 6.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

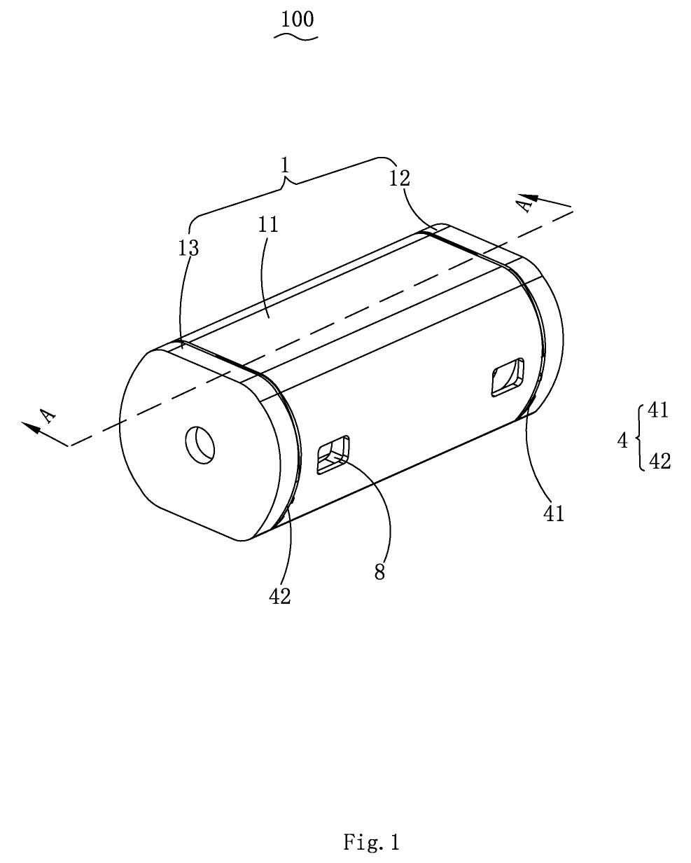

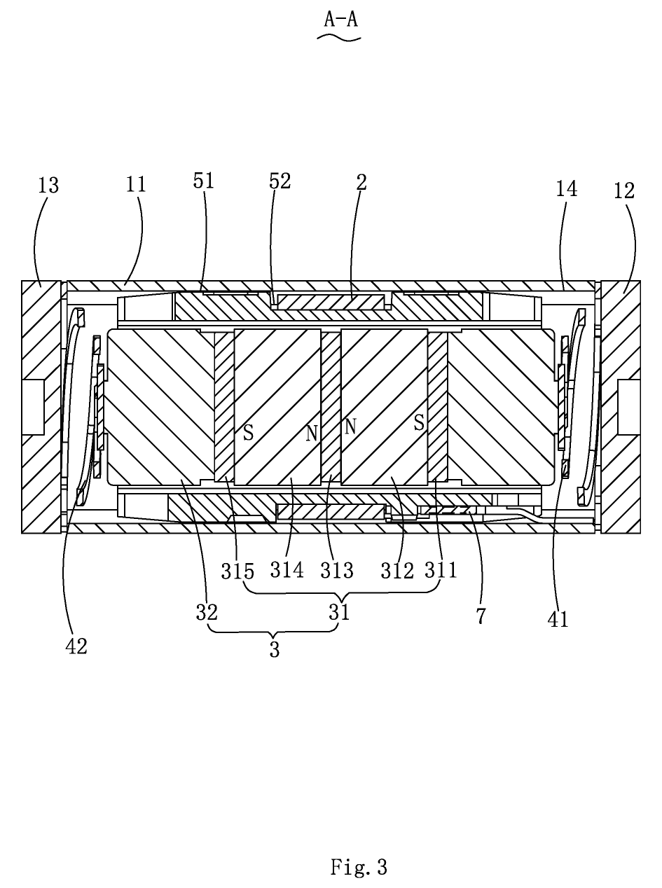

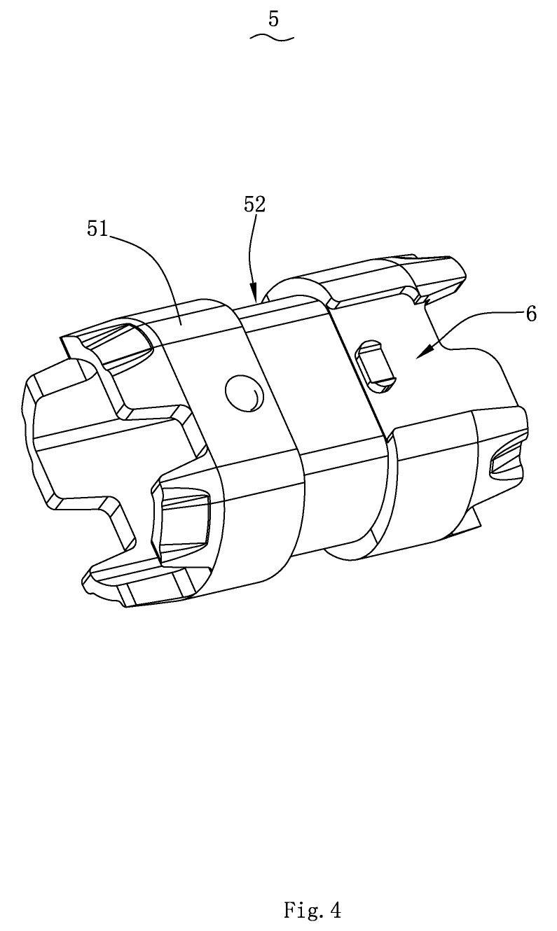

Please refer to FIGS. 1-4 together, a vibration motor 100 provided by an exemplary embodiment of the present disclosure includes a hollow housing 1, a vibration assembly 3 received in the housing 1, a stator 2 located on one side of the vibration assembly 3 at an interval, and an elastic member 4 configured to suspend the vibration assembly 3 in the housing 1. Specifically, the housing 1 includes an inner wall 14 facing the vibration assembly 3. The stator 2 is mounted on the inner wall 14 and is configured to drive the vibration assembly 3 to reciprocate along a first direction.

To be specific, the housing 1 includes a hollow shell 11 with the inner wall 14, a first lid 12 and a second lid 13; the first lid 12 and the second lid 13 are mounted on opposite ends of the shell 11 along the first direction. It should be understood that the shell 11 includes two openings located at two opposite ends.

The stator 2 includes a coil 21 and a copper tube 5 mounted on the inner wall 14. The coil 21 is sleeved on an outer surface of the copper tube 5. It can be understood that the copper tube 5 is a hollow structure with two openings opposite to each other along the first direction.

The vibration assembly 3 includes a magnet unit 31, and two mass blocks 32 respectively fixed on two ends of the magnet unit 31 along the first direction. The elastic member 4 connects the mass block 32 with the housing 1 to suspend the vibration assembly 3 in the housing 1. Specifically, the magnet unit 31 includes a first yoke 311, a second magnet 312, a second yoke 313, a second magnet 314, and a third yoke 315 successively stacked along the first direction. One of the two mass blocks 32 is fixed to the first yoke 311, and the other of the two mass blocks 32 is fixed to the third magnet 315. The first magnet 312 and second magnet 314 are both magnetized along the first direction in a opposite manner.

In order to generate driven force, the magnet unit 31 is arranged opposite to the coil 21. In one embodiment, the magnet unit 31 is located inside the copper tube 5 at an interval. In such manner, the copper tube 5 provides vibration space for the vibration assembly 3.

The elastic member 4 comprises a first spring 41 including an end sandwiched between the first lid 12 and the other end fixed on one of the two mass blocks 32, and a second spring 42 including an end sandwiched between the second lid 13 and the other end fixed on the other one of the two mass blocks 32.

In one embodiment, the copper tube 5 is non-magnetic such that no attractive force or repulsive force would generate between the magnet unit 31 and the copper tube 5. Additionally, induced electromotive force generated between the magnet unit 31 and the copper tube 5 can provide stable damping force for the magnet unit 31, therefore ensuring the stable vibration effect of the vibration assembly 3.

Moreover, the copper tube 5 includes a mounting surface 51 affixed to the inner wall 14, an annular winding slot 52 formed on one side of the copper tube 5 opposite to the housing 1. The wingding slot 52 is depressed from the mounting surface 51 towards the magnet unit 31 and extends along a circumferential direction of the copper tube 5. In one embodiment, the winding slot 52 is annular meaning that the winding slot 52 is a hollow structure in a rectangular annular shape or in a racetrack shape. The coil 21 is wound on the winding slot 52. In one embodiment, an outer surface of the coil 21 is aligned with the mounting surface 51, or is wholly received in the winding slot 52.

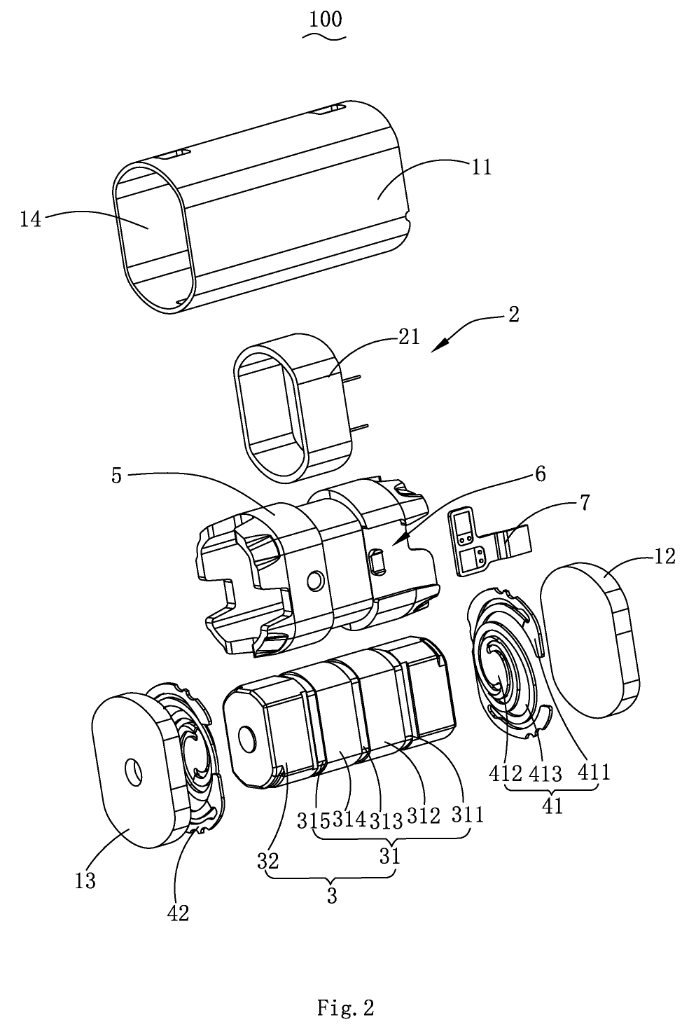

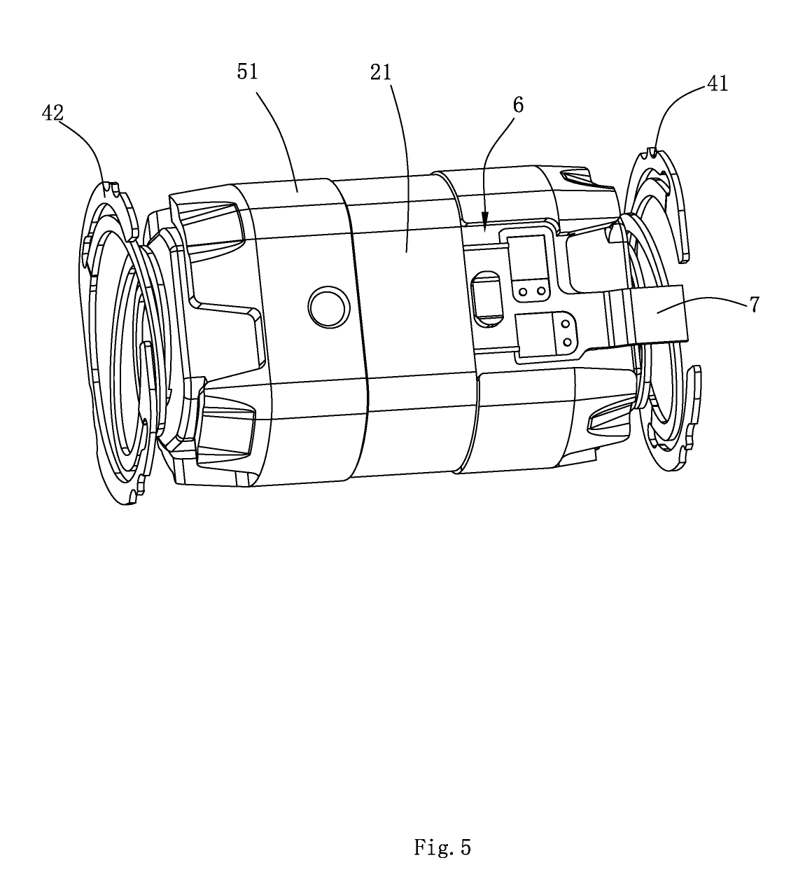

Furthermore, as shown in FIGS. 2-5, the vibration motor 100 includes an electric connector 7 mounted on the copper tube 5 and electrically connected with the coil 21. The electric connector 7 is electrically connected with an external circuit to electrically activate the coil 21. The copper tube 5 further includes a mounting slot 6 formed on one side of the copper tube 5 opposite to the housing 1, the mounting slot 6 is spaced apart from the winding slot 52, the electric connector 7 is mounted in the mounting slot 6, thus saving installation space. In one embodiment, a through hole 8 is provided on the shell 11. The electric connector 7 extends through the through hole 8 to electrically connect with the external circuit.

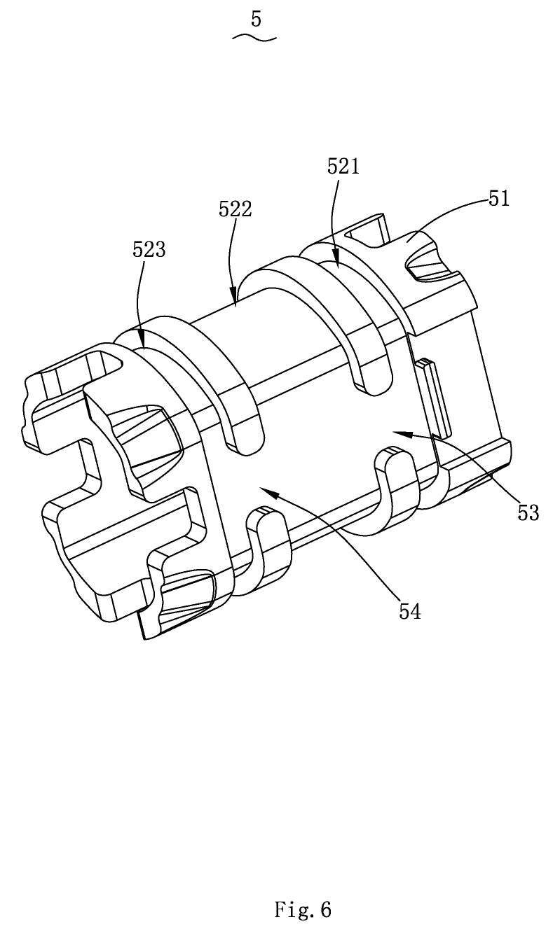

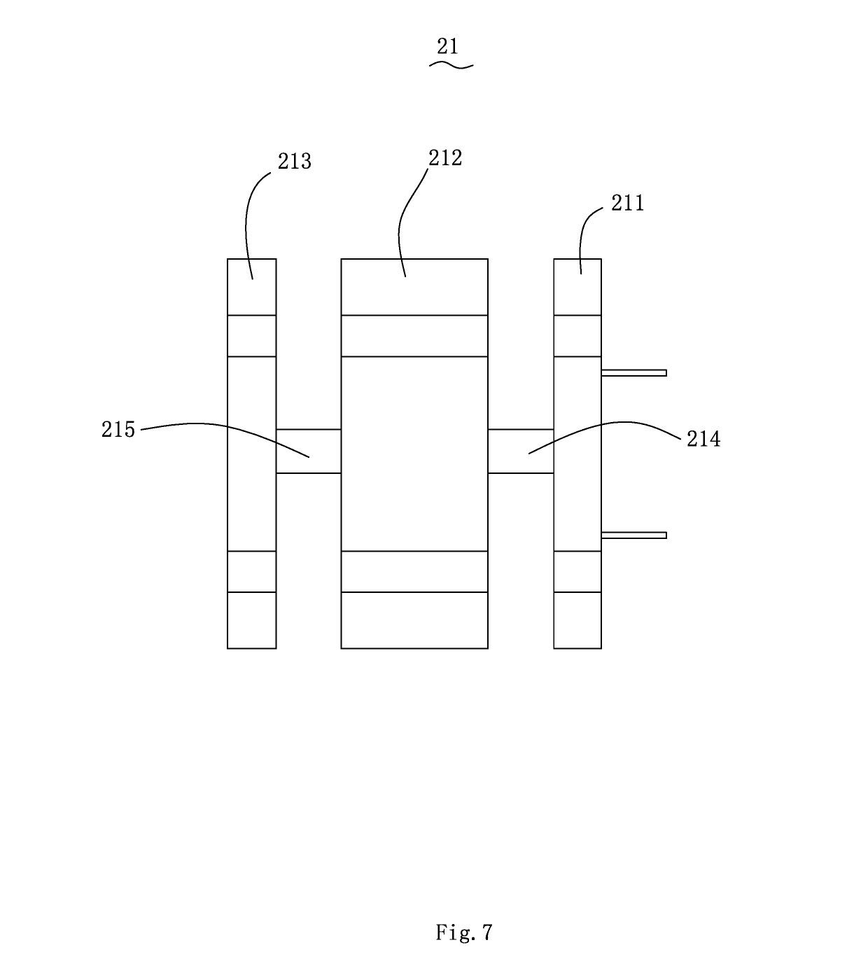

As shown in FIG. 6-7, in the vibration motor provided by another embodiment in present disclosure, the winding slot 52 includes a first winding slot 521, a second winding slot 522 and a third winding slot 523 successively arranged at intervals along the first direction. The copper tube 5 further includes a first connection slot 53 configured to connect the first winding slot 521 and the second winding slot 522, and a second connection slot 54 configured to connect the second winding slot 522 and the third winding slot 523. The coil 21 includes a first wire portion 211 wound on the first winding slot 521, a second wire portion 212 wound on the second winding slot 522, a third wire portion 213 wound on the third winding slot 523, a first connection wire 214 electrically connected the first wire portion 211 with the second wire portion 212, and a second connection wire 215 electrically connected the second wire portion 212 with the third wire portion 213. The first connection wire 214 is received in the first connection slot 53, the second connection wire 215 is received in the second connection slot 54.

Additionally, as shown in FIG. 7, a width of the second wire portion 212 along the first direction is larger than that of the first wire portion 211 and the third wire portion 213. And, the first wire portion 211, the second wire portion 212, and the third wire portion 213 have a same thickness. The first connection slot 53 and the second connection slot 54 are beneficial for winding the coil 21 by one single wire. Thus, the first wire portion 211, the second wire portion 212 and the third wire portion 213 are made by a winding single wire. Specifically, after winding the first wire portion 211 in the first winding slot 521, extend the same wire extends along the first connection slot 53 and then wind the same wire in the second winding slot 522 to obtain the second wire portion 212. Subsequently, extend the same wire extends along the second connection slot 54 and then wind the same wire in the third winding slot 523. If two ends of the coil 21 is lead out at same side, continue to wind the single wire on the third winding slot 523, the second winding slot 522, and the first winding slot 521 successively.

Compared with the related art, the vibration motor in the present disclosure includes a housing, a stator and a vibration assembly suspended in the housing via an elastic member. The vibration assembly includes a magnet unit and two mass blocks fixed on two ends of the magnet unit. The stator includes a cooper tube mounted on an inner wall of the housing and a coil sleeved on the copper tube. The magnet unit is received in the copper tube and oppositely arranged to the coil. When the vibration assembly is driven to reciprocate along a first direction, it passes through the copper tube. Thus, the copper tube generates a magnet field opposite to that of the magnet unit to relieve the movement of the vibration assembly along the first direction so as to achieve stable damping performance.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration motor comprising:
a hollow housing comprising an inner wall;
a stator received in the housing, comprising:
a copper tube mounted on the inner wall; and
a coil sleeved on an outer surface of the copper tube;
a vibration assembly driven by the coil to reciprocate along a first direction, comprising:
a magnet unit located inside the copper tube at an interval and arranged opposite to the coil; and
two mass blocks respectively fixed on two ends of the magnet unit along the first direction; and
an elastic member configured to connect the two mass blocks with the housing to suspend the vibration assembly in the housing.

2. The vibration motor as described in claim 1, wherein the copper tube comprises an annular winding slot depressed from a surface opposite to the housing towards the magnet unit and extending along its circumferential direction, the coil is wound on the winding slot.

3. The vibration motor as described in claim 2, wherein the winding slot comprises a first winding slot, a second winding slot and a third winding slot successively arranged at intervals along the first direction, the copper tube further comprises a first connection slot configured to connect the first winding slot and the second winding slot, and a second connection slot configured to connect the second winding slot and the third winding slot; the coil comprises a first wire portion wound in the first winding slot, a second wire portion wound in the second winding slot, a third wire portion wound in the third winding slot, a first connection wire electrically connected the first wire portion with the second wire portion, and a second connection wire electrically connected the second wire portion with the third wire portion; the first connection wire is received in the first connection slot, the second connection wire is received in the second connection slot.

4. The vibration motor as described in claim 3, wherein a width of the second wire portion along the first direction is larger than that of the first wire portion and the third wire portion.

5. The vibration motor as described in claim 1, wherein the magnet unit comprises a first yoke, a second magnet, a second yoke, a second magnet, and a third yoke successively stacked along the first direction; one of the two mass blocks is fixed to the first yoke, and the other of the two mass blocks is fixed to the third magnet.

6. The vibration motor as described in claim 5, wherein the first magnet and second magnet are both magnetized along the first direction in an opposite manner.

7. The vibration motor as described in claim 1, wherein the housing comprises a hollow shell with the inner wall, a first lid and a second lid; the first lid and the second lid are mounted on opposite ends of the shell along the first direction; the copper tube is fixed on the inner wall of the shell.

8. The vibration motor as described in claim 7, wherein the elastic member comprises a first spring including an end sandwiched between the first lid and the other end fixed on one of the two mass blocks, and a second spring including an end sandwiched between the second lid and the other end fixed on the other one of the two mass blocks.

9. The vibration motor as described in claim 2, further comprising an electric connector mounted on the copper tube and electrically connected with the coil.

10. The vibration motor as described in claim 9, wherein the copper tube further comprises a mounting slot formed on one side of the copper tube opposite to the housing, the mounting slot is spaced apart from the winding slot, the electric connector is mounted in the mounting slot.
